(19) United States
(12) Patent Application Publication
(10) Pub. No.: US 2024/0256134 A1
(43) Pub. Date: Aug. 1, 2024

(54) SELF-BALANCING STORAGE SYSTEM

(71) Applicant: NetApp, Inc., San Jose, CA (US)

(72) Inventors: Jeffrey MacFarland, Wake Forest, NC (US); Brian Mah, Apex, NC (US)

(21) Appl. No.: 18/160,653

(22) Filed: Jan. 27, 2023

(51) Int. Cl. G06F 3/06

(52) U.S. Cl. CPC G06F 3/0611; G06F 3/0634; G06F 3/0653; G06F 3/0673

(57) ABSTRACT

A system can comprise a memory that stores computer executable components, and a processor that executes the computer executable components stored in the memory. The computer executable components can comprise a forecasting component that, based on performance data for a storage system, forecasts a performance metric for a storage unit subset of the storage system, wherein the performance metric is based on saturation of a capacity at the storage system related to the storage unit subset. An execution component can execute a modification at the storage system, wherein the modification at the storage system comprises changing a functioning of the storage system relative to the storage unit subset. The performance metric can be based on at least one of storage capacity or performance capacity for the subset.

### TECHNICAL FIELD

The subject disclosure relates generally to storage system performance and storage capacities, and more specifically to automatic alleviation of saturation of such capacities by self-balancing based on dynamically changing remaining capacities for performance and storage.

### BACKGROUND

Storage system balancing is a process of modifying data at the storage system. Modification can include moving and/or copying data at a node, aggregate of a node, volume of an aggregate, and/or disk of a volume of a storage system, such as for the purpose of achieving improved performance of the storage system.

### SUMMARY

The following presents a summary to provide a basic understanding of one or more embodiments described herein. This summary is not intended to identify key or critical elements, delineate scope of embodiments or scope of claims. Its sole purpose is to present concepts in a simplified form as a prelude to the more detailed description that is presented later. In one or more embodiments described herein, systems, computer-implemented methods, apparatuses, and/or computer program products can facilitate a process to automatically balance a storage system to achieve improved performance of the storage system, such as to alleviate a performance capacity and/or storage capacity at the storage system.

In accordance with an embodiment, a system can comprise a memory that stores computer executable components, and a processor that executes the computer executable components stored in the memory. The computer executable components can comprise a forecasting component that, based on performance data for a storage system, forecasts a performance metric for a storage unit subset of the storage system, wherein the performance metric is based on saturation of a capacity at the storage system related to the storage unit subset; and an execution component that executes a modification at the storage system, wherein the modification at the storage system comprises changing a functioning of the storage system relative to the storage unit subset.

In accordance with another embodiment, a computer-implemented method can comprise forecasting, by a processor, based on performance data for a storage system, a performance metric for a volume of an aggregate of the storage system, wherein the performance metric is based on saturation of at least one of storage capacity or performance capacity at the storage system caused by functioning of the volume; and executing, by the processor, a modification at the storage system, wherein the modification at the storage system comprises changing a functioning of the storage system relative to the volume.

In accordance with yet another embodiment, a computer program product can facilitate an automated process to determine and apply a modification at a storage system. The computer program product can comprise program instructions executable by a processor to cause the processor to execute operations. The operations can comprise obtaining, by the processor, performance data for a volume of an aggregate of the storage system; forecasting, by the processor, based on the performance data, a capacity performance metric for the volume; wherein the performance metric is based on saturation of at least one of storage capacity or performance capacity at the storage system caused by functioning of the volume; ranking, by the processor, a priority of modifying the storage system based on the at least one of the storage capacity or the performance capacity; determining, by the processor, a modification for addressing the performance metric; and executing, by the processor, based on the ranking, the modification of the storage system, wherein the modification causes a level of saturation of capacity at the storage system corresponding to the volume to adjust closer to a selected threshold value.

An advantage of one or more of the above-indicated system, computer-implemented method and/or computer program product can be dynamically adjustable storage system data movement, such as of whole and/or partial volumes of data, such as based on one or more revisions in performance data for one or more aggregates and/or nodes of the storage system. This can be accomplished on a per-aggregate basis, such as with or without interactions between nodes of the storage system. Such self-balancing can comprise implementing non-equal performance and/or storage capacities at two or more aggregates, such as based on characterization of workloads employing those aggregates. As a result, workload performance using the storage system can be improved, such as related to latency and operations.

Another advantage of one or more of the above-indicated system, computer-implemented method and/or computer program product can be setting of dynamically adjustable thresholds upon which the dynamic self-balancing can execute. That is, as opposed to defined static thresholds (e.g., high, medium, and low), full variation of thresholds can be employed. Likewise, ranking of storage units based on performance metrics also can be dynamically adjustable, as opposed to use of defined static ranks (e.g., high, medium, and low). Accordingly, greater correspondence to a desired effect can be achieved for a modification comprising changing a functioning of the storage system (e.g., a move or copy of data of a volume to an aggregate different from an initial aggregate storing the volume prior to the modification).

Yet another advantage of one or more of the above-indicated system, computer-implemented method and/or computer program product can be lack of reliance on human intervention for the execution of one or more modifications at the storage system and/or for the more general balancing of storage and performance capacities of aggregates and performance capacities of one or more CPU's.

Further, another advantage of one or more of the above-indicated system, computer-implemented method and/or computer program product can be proactive balancing, such as before saturation of a performance and/or storage capacity is reached, thus preventing one or more issues, such as aggregate lock-up, that can accompany such saturation actually being reached.

Corresponding to this advantage, use of historical and current performance data to make such predictions can provide more accurate balancing that better corresponds to user needs than can be provided by mere human prediction alone.

Another advantage of any one or more of the aforementioned system, computer-implemented method and/or computer program product can be self-improvement of the system such as by continually training models employed by the system, at a suitable frequency. The models can be employed generate the performance metrics, rankings and/or change determinations to be implemented at the storage system to achieve the aforementioned balancing. Due to the updating, subsequent iterations of use of the one or more of the aforementioned system, computer program product and/or computer-implemented method can be made more accurate and/or efficient.

In one or more embodiments, the models can be updated based on real-time data determined after communication of a detected saturation issue (e.g., storage capacity and/or performance capacity). The update can be performed based on one or more aspects of performance data, issue occurrences, new hardware and/or new software upon which the model has not previously been trained. Due to such updating, subsequent iterations of use of the system can be made more accurate and/or efficient.

### DESCRIPTION OF THE DRAWINGS

FIG. 1 is a block diagram illustrating an example of some components that can be present in a storage system, in accordance with one or more embodiments and/or implementations described herein.

FIG. 2 is a block diagram illustrating an example of some components that can be present in another storage balancing system, in accordance with one or more embodiments and/or implementations described herein.

FIG. 3 is a process flow diagram illustrating an example of one or more inputs and/or outputs of the storage balancing system of FIG. 2, in accordance with one or more embodiments and/or implementations described herein.

FIG. 4 is yet another process flow diagram illustrating an example of one or more processes, inputs and/or outputs of the storage balancing system of FIG. 3, in accordance with one or more embodiments and/or implementations described herein. FIG. 5 also illustrates a graph of exemplary performance capacity used, in accordance with one or more embodiments and/or implementations described herein.

FIG. 5 is graph illustrating use of performance capacity, in accordance with one or more embodiments and/or implementations described herein.

FIG. 6 is a diagram illustrating automatic self-balancing at a storage system, in accordance with one or more embodiments and/or implementations described herein.

FIG. 7 is a process flow diagram illustrating automatic self-balancing at a storage system, in accordance with one or more embodiments and/or implementations described herein.

FIG. 8 is a continuation of the process flow diagram of FIG. 7 of a method of automatic self-balancing at a storage system, in accordance with one or more embodiments and/or implementations described herein.

FIG. 9 is a block diagram illustrating an example of a set of components of a computing system in which one or more embodiments described herein can be facilitated.

FIG. 10 is a block diagram illustrating an example of a system comprising a cloud computing environment and a client side device, in accordance with one or more embodiments described herein.

### DETAILED DESCRIPTION

The technology described herein is generally directed towards determining one or more modifications at a storage system, such as allocation of volumes relative to aggregates and/or nodes, and more particularly to determining such one or more modifications based on performance metrics of storage capacity, CPU performance capacity and aggregate backend performance capacity (herein referred to in combination as “capacities”) of the storage system.

In one or more existing frameworks, due to revisions in a computing workload, addition of a computing workload and/or deletion of a computing workload, these capacities can vary over time, such as dynamically. In one or more existing frameworks, such revisions can be addressed by cluster rebalancing, such as to avoid resource saturation (e.g., saturation of any one of storage capacity, CPU performance capacity and aggregate backend performance capacity).

Regardless of reactive addressing of such revisions, saturation can lead to and/or result in service interruption (e.g., reduction of input/output (I/O), complete stoppage of I/O to client workloads, and/or failure to meet an agreement with respect to workload latency). One or more other negative results that can result due to such saturation can comprise an aggregate and/or a volume being taken offline. CPU and/or aggregate backend performance capacity saturation can cause a node and/or aggregate to have reduction of I/O that can impact numerous volumes and/or numerous clients.

To account for one or more of the aforementioned deficiencies with existing resource saturation addressing frameworks for a storage system, one or more embodiments herein can provide a framework for dynamically making one or more modifications at a storage system to address an occurring and/or predicted resource saturation. Briefly, performance data related to storage capacity, CPU performance capacity and/or aggregate backend performance capacity for any one or more storage units of a storage system can be monitored.

Generally, such current performance data and/or historical performance data can be monitored. One or more performance metrics can be forecast based on the performance data. One or more thresholds can be generated based on the performance metrics. One or more occurring and/or future saturation issues can be predicted based on comparison of current performance metrics and/or historical performance metrics. One or more change determinations can be generated for addressing the occurring and/or future saturation issues, such as represented by current performance metrics satisfying a threshold. One or more executions of modifications, based on the one or more change determinations, can be executed at the storage system. The one or more modifications can respectively comprise changing a functioning of the storage system.

Changing a functioning of the storage system can comprise that a different aggregate and/or node can be used to access a volume that has been moved, that a read/write/get can refer to a different aggregate and/or node due to the volume move, that an aggregate and/or node can operate with greater storage capacity, that a CPU comprised by the storage system can operate with greater performance capacity, and/or that an aggregate backend (e.g., an aggregate from which a volume was moved) can operate with increased performance capacity, without being limited thereto.

The dynamically adjustable balancing mentioned above can be based on continually adjustable (e.g., dynamic) rankings, which can be fully adjustable (e.g., rather than just limited to any defined and/or static rankings such as only high, medium and low). Likewise, the one or more modifications can be executed individually and/or at least partially in aggregate.

Further, one or more of the processes discussed herein can be scalable. One or more change determinations can be executed and/or generated individually and/or at least partially in parallel with one another. Continuous monitoring can be performed of data objects stored at a storage system of interest, to continually (e.g., dynamically) address, such as proactively, storage capacity, CPU performance capacity and/or aggregate backend performance capacity.

Continuous monitoring can be performed to continually (e.g., dynamically) address (e.g., proactively or preemptively) predicted saturation issues related to any one or more of storage capacity, CPU performance capacity, and/or aggregate backend performance capacity.

In addition, various embodiments of the present technology provide for a wide range of technical effects, advantages and/or improvements to computing systems and components. For example, various embodiments may include one or more of the following technical effects, advantages, and/or improvements: 1) proactively addressing saturation of a capacity at a storage system prior to catastrophic failure and/or inability to perform an operation; 2) use of non-static and non-limited rankings (e.g., other than high, medium, low); 3) predicting saturation issues based on historical data; and/or updating a machine learning model, used for outputting the predictions, on a real-time basis, making subsequent iterations of use of the model more accurate and/or efficient.

Direction now turns to one or more embodiments for addressing one or more of the above-identified deficiencies of existing frameworks in addressing the complexities of occurring and/or predictable saturation issues at a storage system.

The following and above-provided detailed description is merely illustrative and is not intended to limit embodiments and/or application or utilization of embodiments. Furthermore, there is no intention to be bound by any expressed or implied information presented in the preceding Summary section or in the Detailed Description section.

### Terminology

As used herein, “client” can refer to a device, network, application, virtual machine, system, machine, component, hardware, software, smart device and/or human.

As used herein, “cost” can refer to time, money, power, storage, memory, bandwidth and/or manual labor.

As used herein, “data” can comprise metadata and can comprise structured and/or unstructured data.

Reference throughout this specification to “one embodiment,” “an embodiment,” “one implementation,” “an implementation,” etc. means that a feature, structure or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures or characteristics may be combined in any suitable manner in one or more embodiments/implementations.

As used herein, “entity” can refer to a device, network, application, virtual machine, system, machine, component, hardware, software, smart device and/or human.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, a node of a storage system can comprise one or more aggregates. An aggregate of a storage system can comprise one or more disks. Disks can contain data from one or more volumes, and volume data can span across multiple disks.

As used herein, “operating parameter” can be a key performance indicator (KPI) such as, but not limited to, degradation, bandwidth and/or service outages.

As used herein, “satisfying” a threshold can refer to meeting and/or exceeding such threshold.

As used herein, “saturation” of a capacity (e.g., storage capacity and/or performance capacity) refers to use of such capacity beyond an optimal range or to a maximum of available resource usage.

As used herein “saturation issue” refers to saturation of a capacity such as storage capacity, CPU performance capacity and/or aggregate backend performance capacity.

As used herein, a “server” can refer to computer software and/or hardware that can provide functionality for other clients, programs or devices, and which can manage access to a centralized resource or service in a network.

As used herein, “storage unit” can refer to a whole storage system, one or more nodes, one or more aggregates, one or more volumes and/or one or more disks. Discussion herein is generally related to use of the term “Storage unit” as meaning a “volume,” however, any other aforementioned definition can apply.

As used herein, “use” can comprise access to.

### General Description

One or more embodiments are now described with reference to the drawings, where like referenced numerals are used to refer to like elements throughout. In the following description, for purposes of explanation, numerous details are set forth to provide a more thorough understanding of the one or more embodiments. It is evident, however, in various cases, that the one or more embodiments can be practiced without these details.

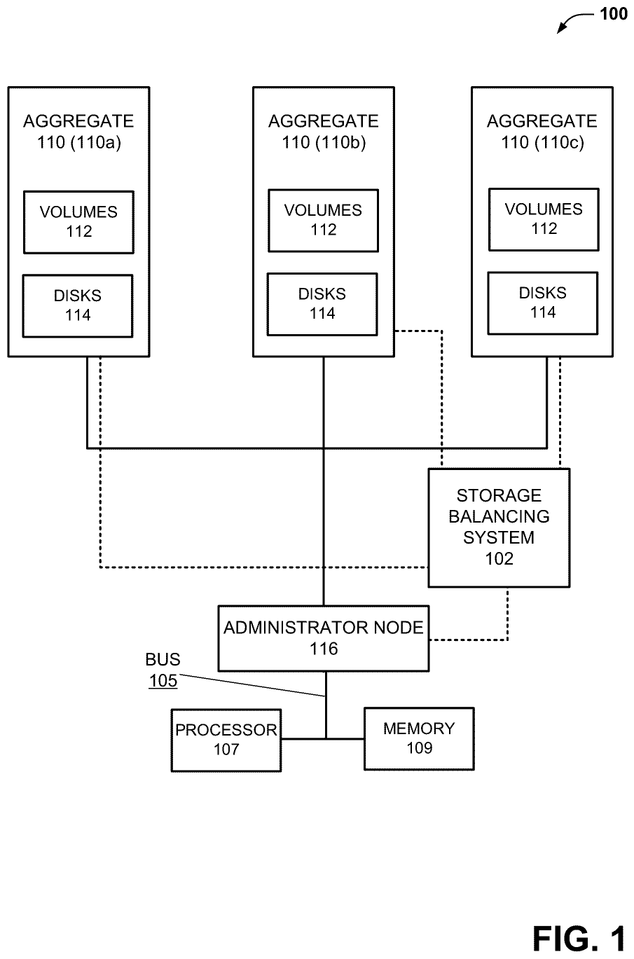

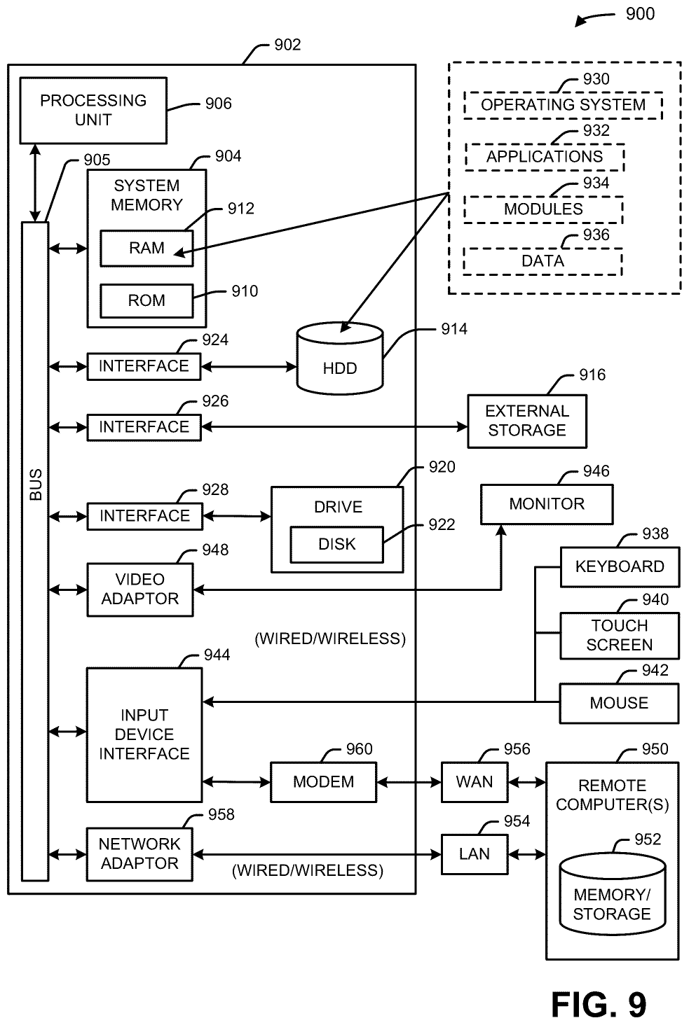

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the computing system 900 illustrated at FIG. 9. In one or more described embodiments, computer and/or computing-based elements can be used in connection with implementing one or more of the systems, devices, components and/or computer-implemented operations shown and/or described in connection with FIGS. 1-8 and/or with other figures described herein.

FIG. 1 illustrates a block diagram illustrating an example of some components that may be present in a storage system, in accordance with one or more embodiments and/or implementations described herein.

FIG. 1 illustrates a storage system architecture 100 comprising a plurality of aggregates 100, each comprising one or more volumes 112, which in turn can comprise one or more elements 114, such as solid-state elements or disks. It is noted that although volumes 112 and physical disks 114 are shown separately for ease of reference, in one or more embodiments, disks 114 can comprise data from one or more volumes 112 and/or volume data can span across multiple disks 114.

The storage system architecture 100 can comprise an administrator node 116 that can control one or more functions and/or revisions relative to the aggregates 110.

The storage system architecture 100 itself can be accessed over a cloud and/or over a network.

More generally, the storage system architecture 100 can comprise any suitable computing devices, hardware, software, operating systems, drivers, network interfaces and/or so forth. For example, the administrator node 116 can be operably coupled to a suitable processor 107 and memory 109 by a bus 105. In one or more embodiments, the administrator node 116 can comprise the processor 107 and/or memory 109.

Communication among between the illustrated aggregates 110, the administrator node 116, and/or the storage balancing system 102 can be by any suitable method. Communication can be facilitated by wired and/or wireless methods including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

In one or more embodiments, the storage system architecture 100 can comprise a processor 107 (e.g., computer processing unit, microprocessor, classical processor and/or like processor). In one or more embodiments, a component associated with storage system architecture 100, as described herein with or without reference to the one or more figures of the one or more embodiments, can comprise one or more computer and/or machine readable, writable and/or executable components and/or instructions that can be executed by processor 107 to facilitate performance of one or more processes defined by such component and/or instruction.

In one or more embodiments, the storage system architecture 100 can comprise a machine-readable memory 109 that can be operably connected to the processor 107. The memory 109 can store computer-executable instructions that, upon execution by the processor 107, can cause the processor 107 and/or one or more other components of the storage system architecture 100 to perform one or more actions. In one or more embodiments, the memory 109 can store computer-executable components.

The storage system architecture 100 and/or a component thereof as described herein, can be communicatively, electrically, operably, optically and/or otherwise coupled to one another via a bus 105 to perform functions of the storage system architecture 100 and/or one or more components thereof and/or coupled therewith. Bus 105 can comprise one or more of a memory bus, memory controller, peripheral bus, external bus, local bus and/or another type of bus that can employ one or more bus architectures. One or more of these examples of bus 105 can be employed to implement one or more embodiments described herein.

In one or more embodiments, storage system architecture 100 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the storage system architecture 100 can reside in the cloud, and/or can reside locally in a local computing environment.

In addition to the processor 107 and/or memory 109 described above, storage system architecture 100 can comprise one or more computer and/or machine readable, writable and/or executable components and/or instructions that, when executed by processor 107, can facilitate performance of one or more operations defined by such component and/or instruction.

Relative to the storage system architecture 100, but not directly shown in FIG. 1, plural high availability (HA) pairs can be provided. Each node of an HA pair can have access to the same backend storage devices such as disks and enclosures. During normal operations, each node can control its own unique subset of storage devices. The nodes of the HA pair together oversee storage read/write operations, recovery operations and/or configuration/provisioning operations. During a node failure in an HA pair, the surviving partner node can take over control of the partner's storage devices and resume operations on behalf of the failed partner. Once the failed node is restored, the storage devices can be returned to the restored node.

As additionally shown at FIG. 1, the storage system architecture 100 can comprise the storage balancing system 102. The storage balancing system 102 can generally address one or more saturation issues (e.g., occurring and/or predicted) at the storage system architecture 100. Although the storage balancing system 102 is illustrated as being comprised by the storage system architecture at FIG. 1, in one or more other embodiments, the storage balancing system 102 can be disposed external to and operably coupled to the storage system architecture 100.

In an example, as will be described further below, using the storage balancing system 102, data from one volume 112 at a first aggregate 110a can be moved to a volume 112 at a second aggregate 110b, and/or an entire volume 112 can be moved from a first aggregate 110a to another aggregate 110b or 110c. This movement can at least partially reduce a capacity saturation, such as a storage capacity saturation, closer to a selected threshold for storage capacity saturation. The threshold can be evaluated for an aggregate, a set of aggregates or for the storage system as a whole.

In another example, as will also be described further below, using the storage balancing system 102, data moved from a first aggregate 110a to a second aggregate 110b can affect the second aggregate 110b. That is, data, such as of a volume 112 can be moved from the first aggregate 110a to at least partially reduce a capacity saturation, such as a storage capacity saturation, at the first aggregate 110a. In response, a capacity saturation, such as a performance capacity saturation, can occur at the second aggregate 110b.

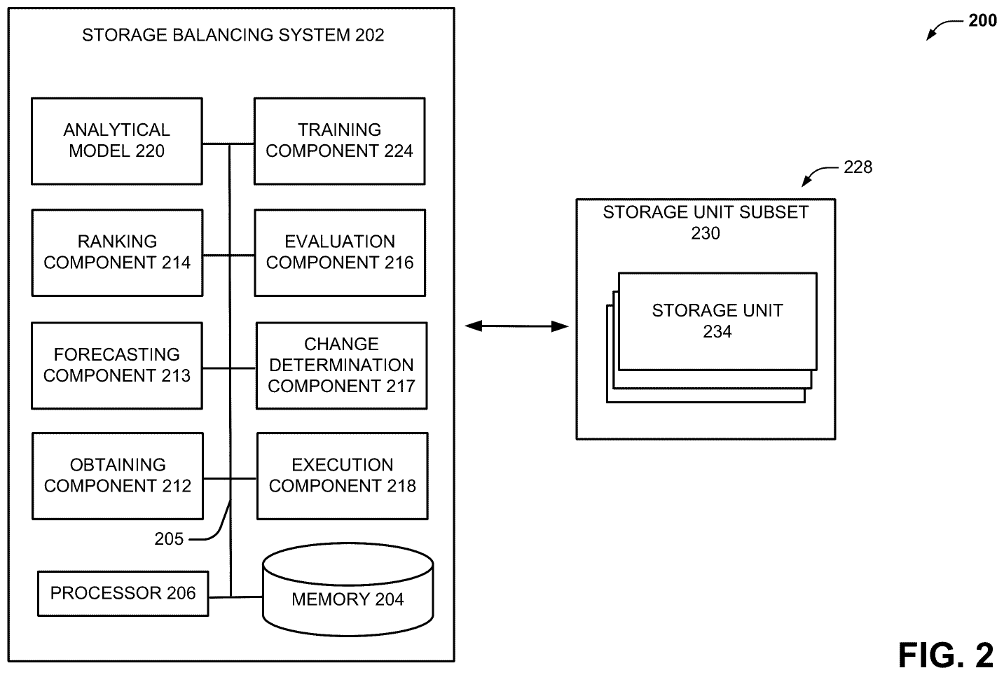

Turning next to FIG. 2, an architecture 200 is illustrated comprising a storage balancing system 202 that can function to aid a storage system 228, such as comprising a subset 230 of storage units 234 by determining a saturation issue (occurring and/or predicted) and applying a change determination at the storage system, relative to the subset 230, to address the saturation issue. The storage balancing system 202 can be operably coupled to the subset 230 by a network, cloud and/or any other suitable manner. Additional description of the storage system 228 comprising the subset 230 is not again provided for sake of brevity. Description provided above relative to the storage system architecture 100 and/or storage system 228 can be applicable to the storage system 228. Likewise, description provided above relative to the storage balancing system 202 can be applicable to the storage balancing system 202.

Generally, the storage balancing system 202 can comprise any suitable computing devices, hardware, software, operating systems, drivers, network interfaces and/or so forth. As illustrated, the storage balancing system 202 comprises an obtaining component 212, forecasting component 213, ranking component 214, evaluation component 216, change determination component 217, execution component 218, model 220 and/or training component 224. These components can be comprised by and/or operably coupled to a processor 206, such as by a bus 205, and/or can be software components of a processor 206. Although, in one or more other embodiments, any one or more of these components can be external to the processor 206. The bus 205 operatively couples the processor 206 and a memory 204.

Communication among the components of the storage balancing system 202 can be by any suitable method. Communication can be facilitated by wired and/or wireless methods including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

In one or more embodiments, the storage balancing system 202 can comprise a processor 206 (e.g., computer processing unit, microprocessor, classical processor and/or like processor). In one or more embodiments, a component associated with storage balancing system 202, as described herein with or without reference to the one or more figures of the one or more embodiments, can comprise one or more computer and/or machine readable, writable and/or executable components and/or instructions that can be executed by processor 206 to facilitate performance of one or more processes defined by such component and/or instruction.

In one or more embodiments, the storage balancing system 202 can comprise a machine-readable memory 204 that can be operably connected to the processor 206. The memory 204 can store computer-executable instructions that, upon execution by the processor 206, can cause the processor 206 and/or one or more other components of the storage balancing system 202 to perform one or more actions. In one or more embodiments, the memory 204 can store computer-executable components.

The storage balancing system 202 and/or a component thereof as described herein, can be communicatively, electrically, operatively, optically and/or otherwise coupled to one another via a bus 205 to perform functions of non-limiting system architecture 200, storage balancing system 202 and/or one or more components thereof and/or coupled therewith. Bus 205 can comprise one or more of a memory bus, memory controller, peripheral bus, external bus, local bus and/or another type of bus that can employ one or more bus architectures. One or more of these examples of bus 205 can be employed to implement one or more embodiments described herein.

In one or more embodiments, storage balancing system 202 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the storage balancing system 202 can reside in the cloud, and/or can reside locally in a local computing environment.

In addition to the processor 206 and/or memory 204 described above, the storage balancing system 202 can comprise one or more computer and/or machine readable, writable and/or executable components and/or instructions that, when executed by processor 206, can facilitate performance of one or more operations defined by such component and/or instruction.

Direction next turns first to the obtaining component 212. The obtaining component 212 can receive, transmit, locate, identify and/or otherwise obtain various performance data (e.g., including metadata) that can be employed by the evaluation component 216. The performance data can comprise capacity data such as related to and/or defining CPU performance capacity, aggregate backend performance capacity, and/or storage capacity.

Storage capacity can refer to remaining free space available within a given volume, aggregate and/or node and the ability to maintain a margin of free space (e.g., storage capacity headroom). Put another way, storage capacity can refer to how much data space is available on an aggregate. An aggregate is a collection of disks (either HDD or SSD or both). Depending on the RAID type of the aggregate, the aggregate's capacity is derived from the total amount of data space provided by the data disks in the aggregate. (Note that other disks in the aggregate can be used for parity.) The aggregate can be carved into volumes (which span across multiple disks) of varying sizes. Volumes can use up the data space in an aggregate.

Aggregate backend performance capacity can refer to utilization of disks that make up the aggregate and relation to client latency, and relative to backend disks and channels coupling to those disks. Such backend can experience bottlenecking issues where performance capacity headroom is not maintained. Such headroom can refer to an amount of remaining aggregate backend performance capacity. For example, in one or more embodiments, performance capacity can be relative to latency, and thus the capacity can be exceeded, but at a cost of increasing latency. Put another way, aggregate performance capacity can refer to how much available aggregate utilization there is for the current workload mix to use before the average disk aggregate latency of the workload mix starts to accelerate. Note that aggregate utilization can be measured as average disk utilization within the aggregate.

CPU performance capacity can refer to amount of available CPU workload, such as where it is desirable to maintain a portion of CPU performance capacity (e.g., performance headroom). For example, a last “x” percentage of CPU performance capacity related to CPU workload can be un-usable where a workload will typically require more than that remaining percentage, and thus a performance headroom can be defined as more than that remaining percentage. Put another way, CPU performance capacity can refer to how much available CPU utilization there is for the current workload mix to use before the average CPU latency of the workload mix starts to accelerate (i.e., latency curve becomes geometric). Note that a workload mix can comprise various types of files, LUN, namespace and/or the like that can be imposed on the system by external client entities.

In an example, the performance data obtained by the obtaining component 212 can be indicative of an occurring and/or predictable saturation of capacity issue (e.g., of storage capacity, CPU performance capacity, and/or aggregate backend performance capacity). Consider the three-aggregate cluster of FIG. 1, where a first aggregate 110a can be exhibiting CPU spikes. One or more volumes 112 can be moved from the first aggregate 110a to a second aggregate 110b to alleviate the CPU performance saturation issue at the first aggregate 110a. The second aggregate 110b can be part of a server virtual machine and/or a locally networked node. The second aggregate 110b likewise can exhibit CPU spikes after such proposed move. Accordingly, based on the performance data obtained by the obtaining component 212, the forecasting component 213, ranking component 314, evaluation component 316, change determination component 317 and/or execution component 318 can address such concerns, as illustrated in detail below.

In one or more embodiments, this performance data further can comprise vendor benchmark data, component classification data, telemetry data, workload, timescale based ranking data, power use data, key performance indicator (KPI) data and/or operation data. Any of these aspects of data can be obtained in a current (e.g., real-time) form and/or as historical (e.g., past) data. Referring to the historical data, such data can be stored at any suitable location, such as the memory 204 and/or another storage database internal to or external to the storage balancing system 202. The various data mentioned above are not meant to be limiting and can be in any suitable format (e.g., logs, lists, matrices and/or code).

The obtaining component 212 can obtain such data at any suitable frequency (e.g., repeated obtaining), on-demand and/or upon request. An administrator entity, user entity and/or default setting can determine the frequency of time. In one or more embodiments, the obtaining component 212 can obtain a request for a volume re-allocation and/or other modification at the storage system 228, such as from a user entity, administrator node and/or administrator entity.

In one or more embodiments, the obtaining component 212 can obtain feedback for implementing an altered ranking (e.g., by the ranking component 214). The feedback can be provided by any of a user entity, administrator node, administrator entity and/or device associated with such entities. That is, the ranking performed by the ranking component 214, as described below, can be dynamically updated based on real-time or current changes in a capacity at a computer system being monitored.

Turning next to the evaluation component 216, this component generally can perform a plurality of operations and/or processes, based at least in part on the performance data obtained by the obtaining component 212. For example, the evaluation component 216 can determine an occurring saturation issue and/or predict a future saturation issue.

Turning first to determination of a saturation issue, the evaluation component 216 can evaluate the performance data obtained by the obtaining component 212. In one or more embodiments, the evaluation component 216 can determine based on comparison of the performance data to default settings and/or thresholds for the storage system 228 that a saturation issue is already occurring. In one or more embodiments, the evaluation component 216 can compare the current obtained performance data to historical performance data. Based on this comparison, the evaluation component 216 can determine that a saturation issue is already occurring.

Additionally, and/or alternatively, based on this comparison, the evaluation component 216 can predict a future saturation issue. For example, one or more aspects of historical data can be representative of an observation of a past saturation issue related to any of the aforementioned capacities. Where the evaluation component 216 determines that the current performance data is similar to, approaching, the same as and/or otherwise aligned with such historical data, the evaluation component 216 further can predict a saturation issue as occurring in the future.

Turning next to forecasting a performance metric, the forecasting component 213 can, based on the obtained performance data, predict a performance metric for one or more storage units 234. This performance metric can be predicted for any suitable range of time, such as more than a week. For example, a performance data can be of a remaining percentage of storage capacity at an aggregate (e.g., one example of a storage unit 234) of the storage system 228. Based on the current storage capacity remaining, and on historical increases in storage at the aggregate (e.g., decreases in storage capacity), a predicted performance metric can comprise an indication that a critical storage capacity headroom (e.g., 80%), will be breached in 125 days. That is, a performance metric can be related to a same category, e.g., storage capacity, as the performance data on which it is based, but can employ the performance data to provide a metric that comprises additional detail that has been derived, calculated and/or otherwise generated.

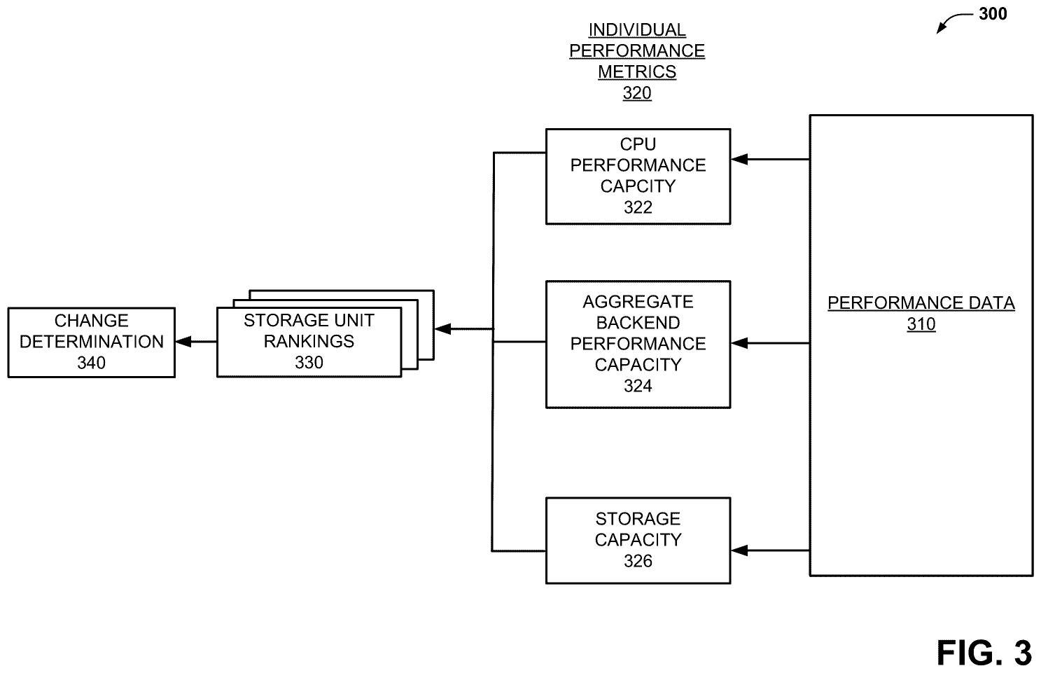

Turning briefly to FIG. 3, and still referring to FIG. 2, such performance metrics (e.g., individual performance metrics 320 at FIG. 3) can be related to any of storage capacity, CPU performance capacity, and/or aggregate backend performance capacity, and thus can be based on any performance data 310 also related to any of storage capacity, CPU performance capacity, and/or aggregate backend performance capacity.

It is noted that in one or more embodiments, use of the one or more systems, computer-implemented methods and/or computer program products described herein is not limited solely to addressing storage capacity, CPU performance capacity, and/or aggregate backend performance capacity relative to a storage system. In one or more other embodiments, additional and/or alternative categories that can be addressed can comprise network capacity of physical interfaces.

Referring now to generating a threshold related to the performance metric, the evaluation component 216 can evaluate the historical data related to one or more known saturation issues. Based on such historical data (e.g., historical performance data related to any of storage capacity, CPU performance capacity, and/or aggregate backend performance capacity), the evaluation component 216 can determine a threshold (e.g., quantity) of such capacity when a saturation issue started to occur (e.g., when negative effects were observed such as latency issues, access issues and/or lock-up or lock-out issues). In one or more embodiments, the thresholds can be assigned for a plurality of performance metrics, to thus be employed by the evaluation component 216 in future determinations of change determinations for the storage system 228.

Discussion now turns to performance data and/or performance metric comparison by the evaluation component 216. That is, the evaluation component 316 can compare current performance data and/or performance metrics for one or more storage units 234 to historical performance data and/or performance metrics for the one or more storage units 234, and/or compare any of these aspects to one or more thresholds for the one or more performance metrics. In one or more cases, such comparing can comprise determining, by the evaluation component 316, a synthetic indicator, such as a combination of historical factors and/or markers, that can have been historically indicative of a capacity (e.g., optimal or saturated) of one or more of the aforementioned capacity saturation types. For example, in one or more cases, a historical rate of increase of a use of a capacity, historical series of data moves, historical series of actions taken, and/or historical decrease in one or more performance metrics can have historically corresponded to a capacity moving out of an optimal range or even to a point of saturation. Based on the comparisons, the evaluation component 216 can proactively determine that a threshold is being approached and/or is already satisfied. One or more indications of such approach and/or satisfaction of a threshold can be communicated in the form of indication data to the ranking component 214.

Discussion now turns from the evaluation component 216 to the ranking component 214. The ranking component 214 generally can evaluate a plurality of the storage units 234 to generate a ranking 330 (FIG. 3). That is the ranking component 214 can evaluate current performance data and/or historical performance data, current performance metrics and/or historical performance metrics (e.g., generated by the evaluation component 216), and/or indication data from the evaluation component 216 to determine a ranking order of storage units with which to cause a modification to address a saturation issue at the storage system 228. In one or more embodiments, a ranking 330 can be based on amount (e.g., quantity) that a performance metric and/or performance data (e.g., current) exceeds a related threshold. Additionally, and/or alternatively, a ranking can be based on a priority of a customer entity that owns and/or uses a storage unit having a saturation issue and/or for which a saturation issue is predicted. Such priority can be based on quantity of storage units employed by a customer entity and/or size of customer entity.

Turning next to generation of a change determination to address the aforementioned and determined saturation issue, the change determination component 217 can, based on the rankings 330 (FIG. 3) generate one or more suggested modifications to be implemented at the storage system 228, which one or more suggested modifications can be provided in the form of a change determination 340 (FIG. 3). A suggested modification at the storage system can be for any storage unit that would address a respective saturation issue (e.g., for a node, aggregate and/or volume). A suggested modification at the storage system can comprise, but is not limited to, movement of a storage unit 234 within the storage system 228 and/or copying and/or moving of data within the storage system 228.

In one or more embodiments, to generate the change determination, the change determination component 217 can predict one or more performance metrics for one or more storage units 234 that would result if the change determination were executed. Based on this prediction, a change determination can be validated and/or revised by the change determination component 217. For example, the change determination component 217, based on historical performance data and historical performance metrics for the storage system 228 can determine that movement of one volume from one aggregate to another will not alleviate an aggregate backend performance capacity saturation of a saturation level, but that movement of two volumes will alleviate the saturation issue. Accordingly, based on this determination, the change determination component 217 can revise and validate a change determination 340.

In one or more embodiments, data defining the validated change determination 340 can be communicated to and/or otherwise obtained by the execution component 218.

Turning next to the execution component 218, this component can generally employ the change determination 340 generated by the evaluation component 216 for directing, instructing, communicating, implementing and/or directly/indirectly making the modification (e.g., moving/copying data of a volume) at the storage system relative to the storage unit of interest (e.g., volume) and/or for more than one storage unit, such as for a plurality of storage units of a storage unit subset (e.g., of one or more aggregates). This employment can comprise direction to, instruction to and/or communication to the administrator node 116.

The modification can be to the storage unit 234 of interest, or to a different storage unit. For example, by arranging (e.g., moving) a second storage unit, the storage unit 234 of interest can be enabled to better perform. This can be, for example, due to reduced bandwidth, memory and/or power usage at an aggregate 110 comprising the storage unit 234 of interest.

Changing a functioning of the storage system can comprise that a different aggregate and/or node can be used to access a volume that has been moved, that a read/write/get can refer to a different aggregate and/or node due to the volume move, that an aggregate and/or node can operate with greater storage capacity, that a CPU (e.g., processor 207) comprised by the storage system can operate with greater performance capacity, and/or that an aggregate backend (e.g., an aggregate from which a volume was moved) can operate with increased performance capacity, without being limited thereto.

The execution component 218 can execute such modification and/or modifications one at a time and/or with any two or more modifications being executed at least partially in parallel with one another. In an example, one or more first modifications executed by the execution component 318 can be individually executed. Based on data representing user entity feedback, modifications can increase in frequency and/or in quantity of modifications being executed in parallel to one another.

It will be appreciated that the aforementioned processes can be repeated based on newly-obtained performance data, such as, but not limited to, new workload characterization data, CPU performance data, aggregate backend performance data and/or storage capacity data for any storage unit of the storage system, such as obtained by the obtaining component 212.

For example, the ranking component 214 can re-rank at least one storage unit 234, such as based on re-generation of at least one performance metric and/or based upon a new comparison of updated performance data for the storage unit 234 as compared to relevant historical data. This re-generation can be performed at a frequency of time and/or upon notification from the obtaining component 212 of newly available performance data, such as absent notification from a user entity/administrator entity external to the storage balancing system 202. An administrator entity, user entity and/or default setting can determine the frequency of time.

For another example, the change determination component 217, such as based on the re-ranking, can determine another change determination (e.g., for a modification to one or more storage units 234 of the storage system 228). This can be performed at a frequency of time and/or upon notification from the ranking component 214 of a newly available ranking, and/or upon notification from the obtaining component 212 of newly available performance data, such as absent notification from a user entity/administrator entity external to the storage balancing system 202. An administrator entity, user entity and/or default setting can determine the frequency of time.

For yet another example, the execution component 218 can re-execute/execute a new modification at the storage system 228, based on the new/other change determination, relative to the one or more storage units 234. This can be performed at a frequency of time and/or upon notification from the evaluation component 216 of a newly available change determination, such as absent notification from a user entity/administrator entity external to the storage balancing system 202. An administrator entity, user entity and/or default setting can determine the frequency of time.

In one or more embodiments, the storage balancing system 202 can comprise a model 220. The model 220 can be, can comprise and/or can be comprised by a classical model, such as a predictive model, neural network, and/or artificial intelligent model. An artificial intelligent model and/or neural network (e.g., a convolutional network and/or deep neural network) can comprise and/or employ artificial intelligence (AI), machine learning (ML), and/or deep learning (DL), where the learning can be supervised, semi-supervised, self-supervised, semi-self-supervised and/or unsupervised. For example, the model 220 can comprise an ML model.

The model 220 generally can accordingly evaluate known performance data, such as historical performance data and/or current performance data. In one or more cases, the model 220 can aid the evaluation component 216 in generation a prediction of a saturation issue. That is, the model 220 can obtain current performance data and/or historical performance data for a storage unit 234, and based on the performance data, can forecast a performance metric for a storage unit 234 of the storage system 228. That is, the model 220 can determine from historical performance data that a capacity issue occurred in the past, and that current performance data is trending in a direction of meeting and/or exceeding said historical performance data.

In another example, the model 220 can aid the ranking component 214 in determining a ranking of one or more storage units 234. For example, the model 220 can obtain the performance metrics from the forecasting component 213, obtain the thresholds from the evaluation component 216, and/or obtain current performance data and/or historical performance data. Based on this information, the model 220 can compare current performance metrics for one or more storage units 234 to the thresholds and rank the storage units 234. In one or more embodiments, the model 220 can determine, based on the comparison, that a performance metric for a storage unit 234 has satisfied (e.g., met and/or exceeded) a threshold and can communicate to the evaluation component 216 data representing a notification of potential capacity issue relative to the storage unit 234.

For yet another example, the model 220 can aid the evaluation component 216 by obtaining a ranking of one or more storage units 234, and/or identification of one or more storage units 234 related to a potential and/or predicted capacity issue, and can further based on this information, communicate to the evaluation component 216, data representing a notification for a request for a change determination based on the ranking, and relative to the one or more storage units 234.

For still another example, the model 220 can aid the change determination component 217 in determining a change determination that can alleviate a potential and/or predicted capacity issue. That is, the model 220 can, based on a ranking of one or more storage units 234, and on a comparison of current, historical and predicted performance metrics, determine a modification to the storage system 228 that can comprise changing a capacity performance metric (e.g., CPU performance capacity, aggregate backend capacity, and/or storage capacity) for an aggregate and/or node of the storage system 228 such that a threshold indicating issue is no longer satisfied, and/or such that a threshold indicating no issue is instead satisfied.

Alternatively, it will be appreciated that the storage balancing system 202 can function absent use of the model 220 for any one or more of the aforementioned processes.

Generally, the model 220 can be trained, such as by a training component 224, on a set of training data that can represent the type of data for which the storage balancing system 202 will be used. That is, the model 220 can be trained on historical and/or current data comprising performance data such as defining/representing CPU performance capacity, aggregate backend capacity, and/or storage capacity. Likewise, the model 220 can be trained on new software and/or hardware of the storage system 228, such as relative to a new node, aggregate and/or volume.

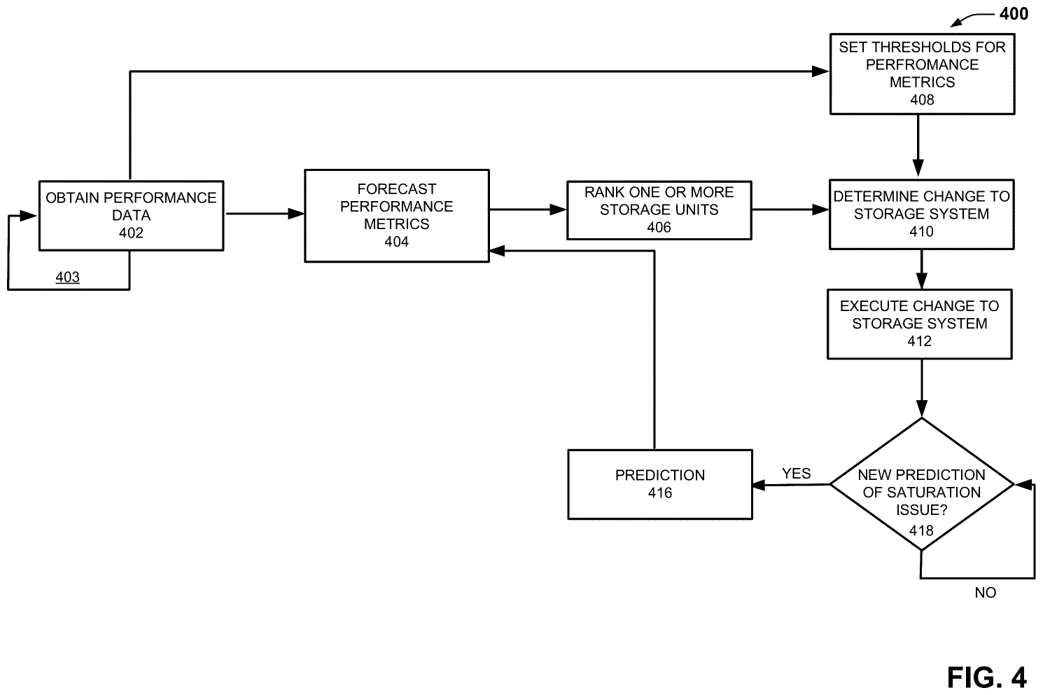

Referring now briefly to FIG. 4, an example process flow 400 is illustrated as a summary of one or more processes, inputs and/or outputs of the storage balancing system 202. As illustrated, a process 402 of obtaining performance data can be performed, such as by the obtaining component 212. It is noted that the process 402 of obtaining performance data can be repeatedly performed (e.g., at loop 403) in real time, at any suitable frequency, on demand, and/or upon request, such as to allow for collection of data that can be employed (e.g., by the evaluation component 216) to proactively determine if a saturation issue is predicted.

The performance data can be employed for process 404 of forecasting performance metrics, such as by the forecasting component 213. Based on the forecast, a process 406 of ranking one or more storage units of a storage system can be performed, such as by the ranking component 214.

The performance data also can be employed for process 408 of determining and setting (e.g., by the evaluation component 216) one or more thresholds for performance metrics upon which the determination of modification at the storage system can be based.

Further, the change determination component 217 can perform a process 410 of determining a modification at the storage system based on current performance metrics for a storage unit of the storage system satisfying such performance metric threshold. In response, and based on the change determination to be implemented, the execution component 218 can perform a process 412 of executing/implementing the modification at the storage system.

Next, a determination 414 of whether a new prediction of a saturation issue has been generated, such as by the evaluation component 216 based on performance data collected by the obtaining component 212. If the answer is no, the determination 414 can be re-evaluated at a suitable frequency, on demand and/or upon request. If the answer is yes, and a prediction 416 is generated, process 404 of forecasting of performance metrics can again be performed, and the process started over to execute another modification at the storage system to address the prediction 416.

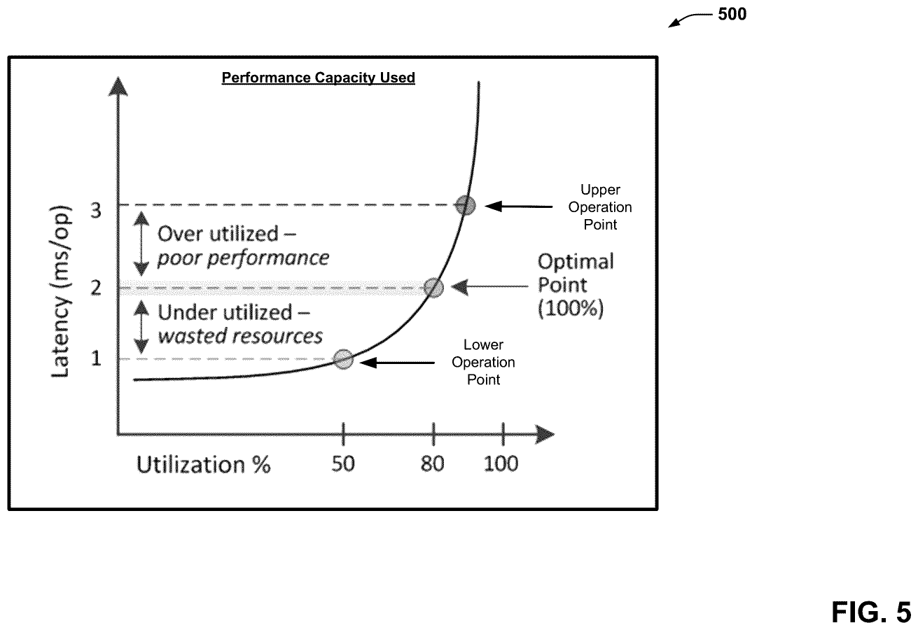

Turning next to the Performance Capacity Used graph 500 at FIG. 5, this graph illustrates example performance capacity utilization (x-axis) as compared to latency (y-axis). That is, the graph comprises a latency versus utilization curve for a resource and identifies, at three points (upper, optimal, and lower) three indices where an operation point could be located. Such graph generally illustrates one or more processes that can be employed by the evaluation component 216.

Relative to the storage balancing system 202, the performance capacity of all the nodes in a cluster are being maximized. If performance capacity is achieved at a utilization of approximately 0 to approximately 80 percent, the goal of an optimized system can be to ensure that each node that comprises the cluster is at approximately 80% utilization, thereby fully maximizing all the performance capacity of the cluster. That is, maximum resource (CPU/aggregate) usage of the nodes can be achieved while maintaining an acceptable latency.

For example, an optimal usage of the performance capacity, such as of an aggregate and/or CPU is indicated at 80%. Overutilization is much, higher such as at about 88%, which can define a saturation. This can be because the remaining 12% can be insufficient based on historical upticks in usage of the performance capacity. Likewise, the lower point can define only 50% utilization of the performance capacity, which can define a wasted performance capacity, although still one for which saturation is not an issue.

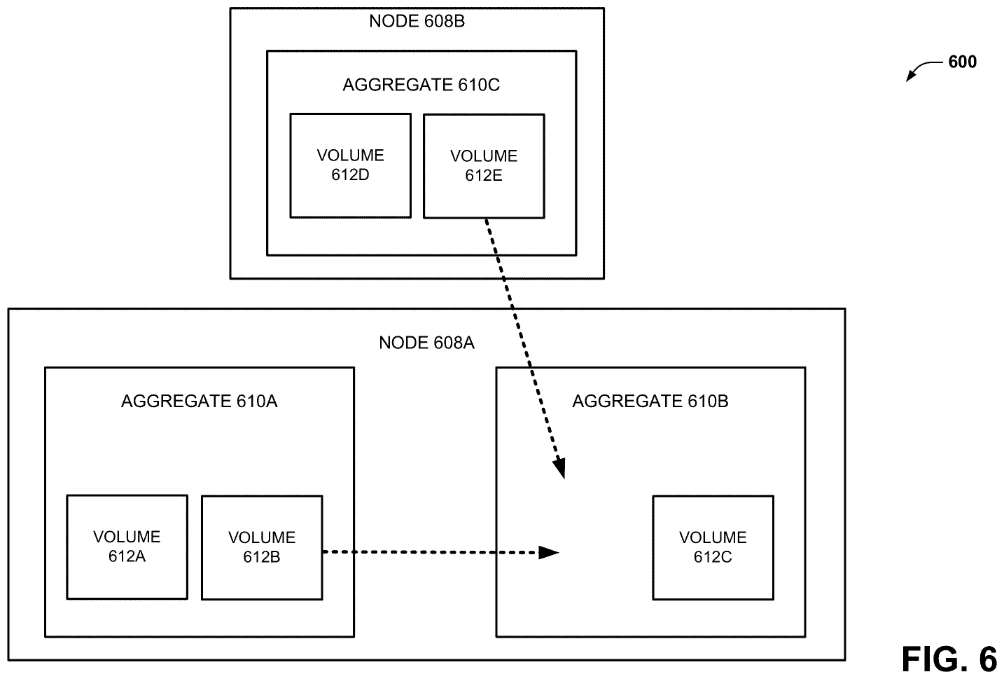

Turning now to FIG. 6, the process 412 of executing a modification comprising changing a functioning of the storage system relative to the storage unit of interest (e.g., an aggregate, a volume and/or a disk) is illustrated for two different examples. With respect to FIG. 6, the storage units for which the modifications executed are each a volume of the respective storage system.

As illustrated at FIG. 6, the storage system 600 can comprise at least a pair of nodes 608A and 608B. Node 608A can comprise aggregates 610A and 610B. Node 608B can comprise aggregate 610C. Aggregate 610A can comprise a pair of volumes 612A and 612B. Aggregate 610B can comprise a volume 612C. Aggregate 610C can comprise a pair of volumes 612D and 612E. Based on a prediction of storage capacity saturation at volume 612B, a change determination can be made proposing to move volume 612B from aggregate 610A to aggregate 610B, within the same node 608A. Based on a prediction of aggregate backend performance capacity saturation at aggregate 610C, a change determination can be made proposing to move volume 612E from an aggregate at node 608B to an aggregate at node 608A.

That is, a change determination can be made (e.g., by the change determination component 217) comprising one or more modifications at a storage system. Where plural modifications are comprised by a change determination, such plural modifications can be proposed relative to different aggregates, volumes and/or nodes. Such aggregated modifications can comprise moves and/or copies of data within a node or between/among two or more nodes.

Further, aggregated modifications can be determined at least partially in parallel with one another, rather than separately. For example, each of volume 612E and volume 612B are being proposed to be moved to the same aggregate 610B, but for different reasons. Accordingly, movement of volume 612B can have a greatest impact on an individual performance metric 320 of storage capacity 326 to node 608A and/or aggregate 610A, while movement of volume 612E can have a greatest impact of an individual performance metric 320 of aggregate backend performance capacity 324 to node 608B and/or aggregate 610C.

Relative to the result of the proposed modification, it can be determined that any one or more of CPU performance capacity 326, storage capacity 322 and/or aggregate backend performance capacity 324 relative to and/or for the node 608A and/or aggregate 610B can be impacted.

Likewise, the change determination component 217 can consider any one or more of these individual performance metrics 320 can be affected relative to the volume 612A left behind at aggregate 610A and/or the volume 612C (e.g., which is at an aggregate 610B to which two additional volumes 612B and 612E are to be added upon execution of the respective change determination).

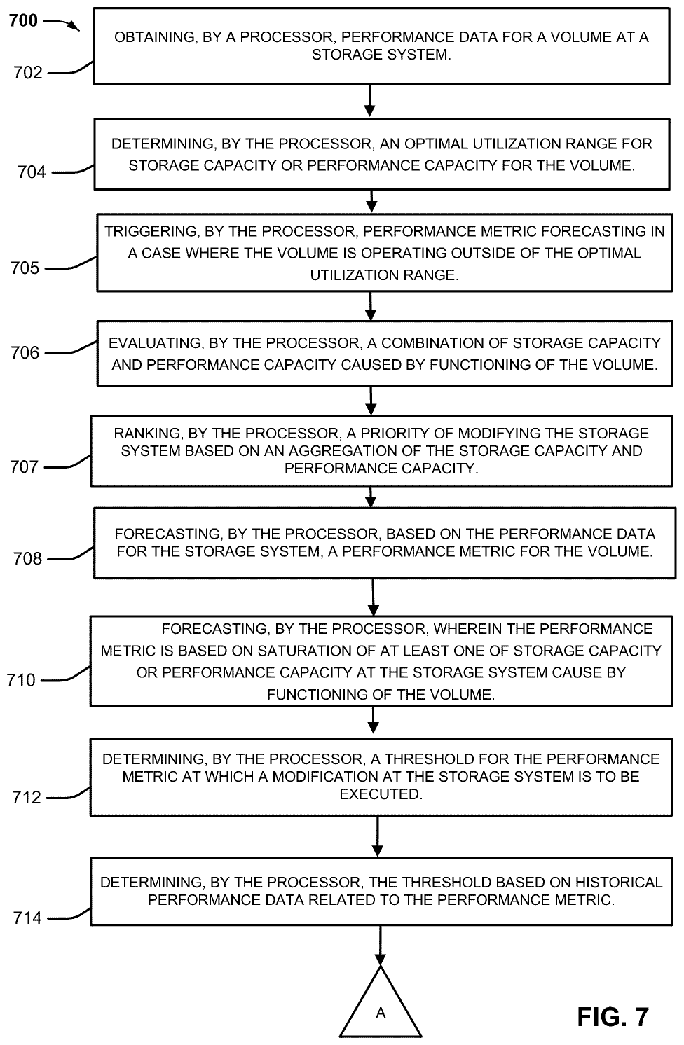

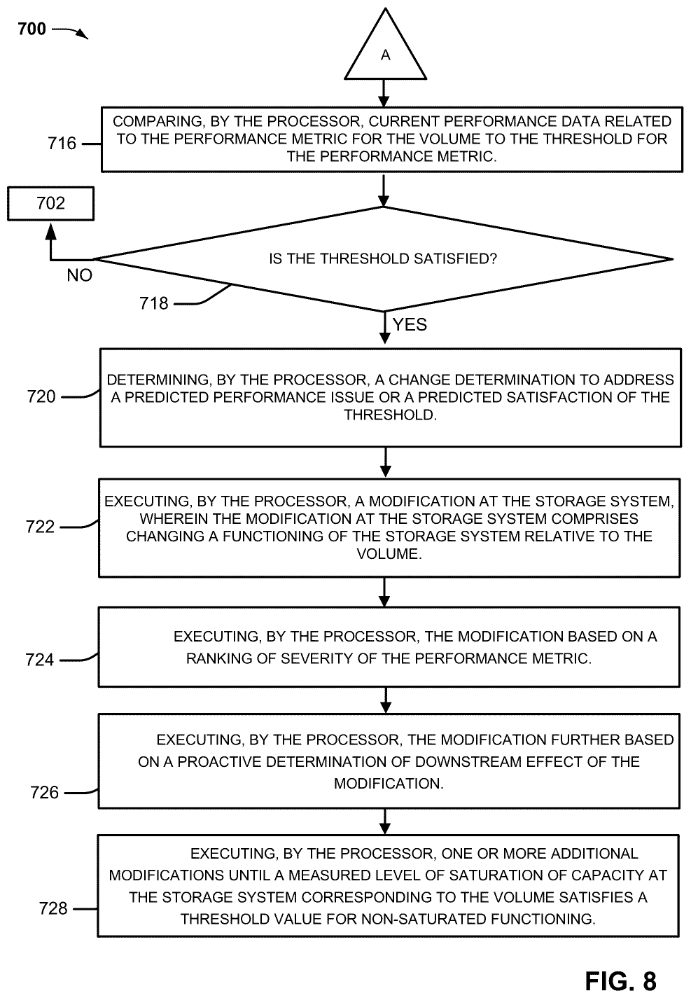

Turning next to FIGS. 7 and 8, illustrated is a flow diagram of an example, non-limiting method 700 that can facilitate a process to determine and address a capacity saturation issue at a storage system, in accordance with one or more embodiments described herein, such as the non-limiting architecture 200. Repetitive description of like elements and/or processes employed in respective embodiments is omitted for the sake of brevity. It is noted that the non-limiting method 700 continues from FIG. 7 to FIG. 8.

Turning first to 702, the non-limiting method 700 can comprise obtaining, by a processor (e.g., by the obtaining component 212), performance data for a volume at a storage system. The performance data (e.g., performance data 310) can comprise at least one of an amount of a storage capacity or a performance capacity (e.g., CPU performance capacity and/or aggregate backend capacity) for one or more of a plurality of volumes (e.g., of a storage unit subset).

At 704, the non-limiting method 700 can comprise determining, by the processor (e.g., by the evaluation component 216), an optimal utilization range for storage capacity or performance capacity for the volume.

At 705, the non-limiting method 700 can comprise triggering, by the processor (e.g., by the evaluation component 216), performance metric forecasting in a case where the volume is operating outside of the optimal utilization range.

At 706, the non-limiting method 700 can comprise evaluating, by the processor (e.g., by the obtaining component 212), a combination of storage capacity and performance capacity caused by functioning of the volume.

At 707, the non-limiting method 700 can comprise ranking, by the processor (e.g., by the ranking component 214), a priority of modifying the storage system based on an aggregation of the storage capacity and performance capacity.

At 708, the non-limiting method 700 can comprise forecasting, by the processor (e.g., by the forecasting component 213), based on the performance data for the storage system, a performance metric (e.g., performance metric 320) for the volume (e.g., of an aggregate of the storage system).

At 710, the non-limiting method 700 can comprise forecasting, by the processor (e.g., by the forecasting component 213), wherein the performance metric is based on saturation of at least one of storage capacity or performance capacity at the storage system caused by functioning of the volume.

At 712, the non-limiting method 700 can comprise determining, by the processor (e.g., by the evaluation component 216), a threshold for the performance metric at which a modification at the storage system is to be executed. For example, the threshold can define a performance headroom indicative of onset of performance issues.

At 714, the non-limiting method 700 can comprise determining, by the processor (e.g., by the evaluation component 216), the threshold based on historical performance data related to the performance metric. For example, historical performance data can define a performance headroom metric (e.g., for CPU or aggregate backend) at which performance issues start.

At 716, the non-limiting method 700 can comprise comparing, by the processor (e.g., by the evaluation component 216), current performance data related to the performance metric for the volume to the threshold for the performance metric.

At 718, the non-limiting method 700 can comprise determining, by the processor (e.g., by the evaluation component 216), whether the threshold is satisfied, such as by comparing the threshold to current performance metrics for the volume. Where the answer is yes, the non-limiting method 700 can proceed to step 720. Where the answer is no, the non-limiting method 700 can proceed back to step 702, such as starting over the non-limiting method 700.

At 720, the non-limiting method 700 can comprise determining, by the processor (e.g., by a change determination component 217) a change determination to address (e.g., account for) a predicted performance issue or a predicted satisfaction of the threshold.

At 722, the non-limiting method 700 can comprise executing, by the processor (e.g., by the execution component 218), a modification (e.g., based on the change determination) at the storage system, wherein the modification at the storage system comprises changing a functioning of the storage system relative to the volume.

At 724, the non-limiting method 700 can comprise executing, by the processor (e.g., by the evaluation component 216), the modification based on a ranking of severity of the performance metric.

At 726, the non-limiting method 700 can comprise executing, by the processor (e.g., by the evaluation component 216), the modification further based on a proactive determination of downstream effect of the modification.

At 728, the non-limiting method 700 can comprise executing, by the processor (e.g., by the execution component 218), one or more additional modifications until a measured level of saturation of capacity at the storage system corresponding to the volume satisfies a threshold value for non-saturated functioning.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In summary, one or more systems, computer program products, and/or computer-implemented methods are provided herein directed to an automated process to determine and apply a modification at a storage system. A system can comprise a memory that stores computer executable components, and a processor that executes the computer executable components stored in the memory. The computer executable components can comprise a forecasting component that, based on performance data for a storage system, forecasts a performance metric for a storage unit subset of the storage system, wherein the performance metric is based on saturation of a capacity at the storage system related to the storage unit subset. An execution component can execute a modification at the storage system, wherein the modification at the storage system comprises changing a functioning of the storage system relative to the storage unit subset. The performance metric can be based on at least one of storage capacity or performance capacity for the subset.

An advantage of one or more of the above-indicated system, computer-implemented method and/or computer program product can be dynamically adjustable storage system data movement, such as of whole and/or partial volumes of data, such as based on revisions in performance data for one or more aggregates and/or nodes of the storage system. This can be accomplished on a per-aggregate basis, such as with or without interactions between nodes of the storage system. Such self-balancing can comprise implementing non-equal performance and/or storage capacities at two or more aggregates, such as based on characterization of workloads employing those aggregates. As a result, workload performance using the storage system can be improved, such as related to latency and operations.

Another advantage of one or more of the above-indicated system, computer-implemented method and/or computer program product can be setting of dynamically adjustable thresholds upon which the dynamic self-balancing can execute. That is, as opposed to defined static thresholds (e.g., high, medium, and low), full variation of thresholds can be employed. Likewise, ranking of storage units based on performance metrics also can be dynamically adjustable, as opposed to use of defined static ranks (e.g., high, medium, and low). Accordingly, greater correspondence of desired effect to modification at the storage system (e.g., a move or copy of data of a volume to an aggregate different from an initial aggregate storing the volume prior to the modification) can be achieved.

Yet another advantage of one or more of the above-indicated system, computer-implemented method and/or computer program product can be lack of reliance on human intervention for the execution of one or more modifications to the storage system and/or for the more general balancing of storage and performance capacities of aggregates and performance capacities of one or more CPU's.

Further, another advantage of one or more of the above-indicated system, computer-implemented method and/or computer program product can be proactive balancing, such as before saturation of a performance and/or storage capacity is reached, thus preventing one or more issues, such as aggregate lock-up, that can accompany such saturation actually being reached.

Corresponding to this advantage, use of historical and current performance data to make such predictions can provide more accurate balancing that better corresponds to user needs than can be provided by mere human prediction alone.

Another advantage of any one or more of the aforementioned system, computer-implemented method and/or computer program product can be self-improvement of the system such as by continually training models employed by the system, at a suitable frequency. The models can be employed generate the performance metrics, rankings and/or change determinations to be implemented at the storage system to achieve the aforementioned balancing. Due to the updating, subsequent iterations of use of the one or more of the aforementioned system, computer program product and/or computer-implemented method can be made more accurate and/or efficient.

In one or more embodiments, the models can be updated based on real-time data determined after communication of a detected saturation issue. The update can be performed based on one or more aspects of performance data, issue occurrences, new hardware and/or new software upon which the model has not previously been trained. Due to such updating, subsequent iterations of use of the system can be made more accurate and/or efficient. That is, the one or more of the aforementioned system, computer program product and/or computer-implemented method.

Indeed, in view of the one or more embodiments described herein, a practical application of the systems, computer-implemented methods, and/or computer program products described herein can be the implementation of modification at a storage system comprising changing a functioning of the storage system relative to a storage unit for which the modification was implemented. Yet another practical application can be the ability to proactively predict a saturation issue related to storage capacity, CPU performance capacity and/or aggregate backend performance capacity, and to proactively address such predicted saturation issue by one or more modifications to software and/or hardware at the storage system. In view thereof, workloads employing the storage system can be better planned and made more efficient. Overall, such computerized tools can constitute a concrete and tangible technical improvement in the field of storage system usage.

One or more embodiments described herein can be inherently and/or inextricably tied to computer technology and cannot be implemented outside of a computing environment. For example, one or more processes performed by one or more embodiments described herein can more efficiently, and even more feasibly, provide program and/or program instruction execution, such as relative to storage capacity, CPU performance capacity and/or aggregate backend performance capacity balancing, as compared to existing systems and/or techniques lacking such approach(es). Systems, computer-implemented methods, and/or computer program products facilitating performance of these processes are of great utility in the field of storage system usage and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately, and/or effectively electronically predict a saturation issue related to storage capacity, CPU performance capacity and/or aggregate backend performance capacity, and/or automatically cause a modification at a storage system to address such predicted saturation as the one or more embodiments described herein can facilitate these processes. And, neither can the human mind nor a human with pen and paper electronically effectively electronically perform these processes, as conducted by one or more embodiments described herein.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, cloud computing systems, computer architecture, and/or another technology.

One or more embodiments described herein can be fully operational towards performing one or more other functions (e.g., fully powered on, fully executed and/or another function) while also performing one or more of the one or more operations described herein.

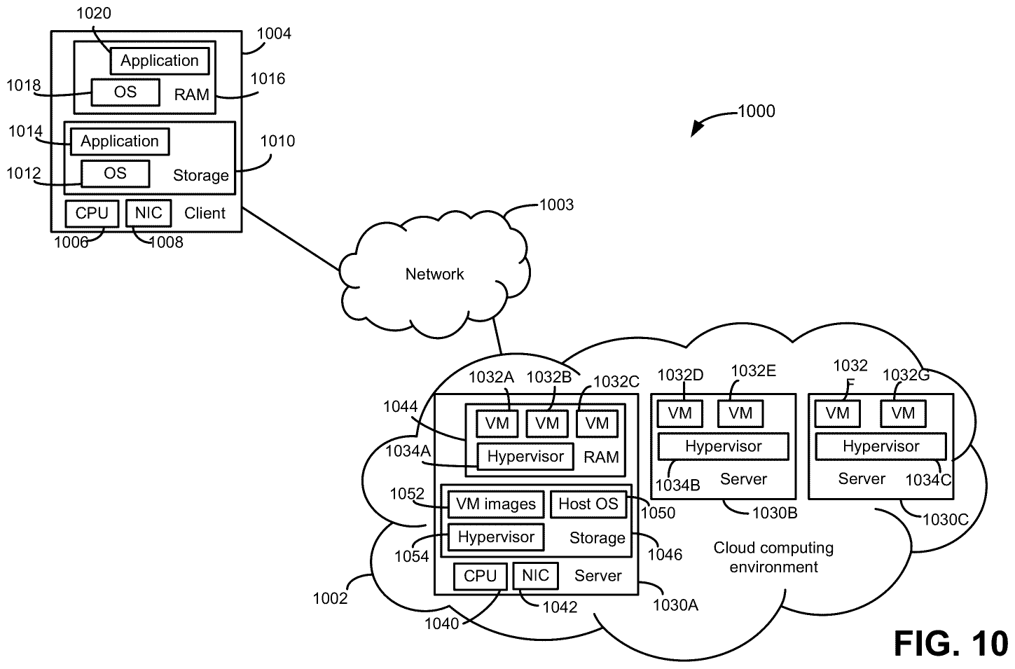

Turning next to FIGS. 9 and 10, a detailed description is provided of additional context for the one or more embodiments described herein at FIGS. 1-8.

FIG. 9 and the following discussion are intended to provide a brief, general description of a suitable computing system 900 in which one or more embodiments described herein at FIGS. 1-8 can be implemented. For example, one or more components and/or other aspects of embodiments described herein can be implemented in or be associated with, such as accessible via, the computing system 900. Further, while one or more embodiments have been described above in the general context of computer-executable instructions that can run on one or more computers, those skilled in the art will recognize that one or more embodiments also can be implemented at least partially in parallel with other program modules and/or as a combination of hardware and software.

Generally, program modules include routines, programs, components and/or data structures, that perform tasks and/or implement abstract data types. Moreover, the aforedescribed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based consumer electronics and/or programmable consumer electronics, any of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD), and/or other optical disk storage, magnetic cassettes, magnetic tape, magnetic disk storage and/or other magnetic storage devices, solid state drives or other solid state storage devices and/or other tangible and/or non-transitory media which can be used to store defined information. In this regard, the terms “tangible” or “non-transitory” herein as applied to storage, memory and/or computer-readable media, are to be understood to exclude only propagating transitory signals per se as modifiers and do not relinquish rights to all standard storage, memory, and/or computer-readable media that are not only propagating transitory signals per se.

Computer-readable storage media can be accessed by one or more local or remote computing devices, e.g., via access requests, queries, and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared, and/or other wireless media.

With reference still to FIG. 9, the example computing system 900 for implementing one or more embodiments of the aspects described herein can include a computer 902, the computer 902 including a processing unit 906, a system memory 904 and/or a system bus 905. One or more aspects of the processing unit 906 can be applied to processor such as 206 of the non-limiting architecture 200. The processing unit 906 can be implemented at least partially in parallel with and/or alternatively to processor such as 206.

Memory 904 can store one or more computer and/or machine readable, writable and/or executable components and/or instructions that, when executed by processing unit 906 (e.g., a classical processor, and/or like processor), can facilitate performance of operations defined by the executable component and/or instruction. For example, memory 904 can store computer and/or machine readable, writable, and/or executable components and/or instructions that, when executed by processing unit 906, can facilitate execution of the one or more functions described herein relating to non-limiting architecture 200, as described herein with or without reference to the one or more figures of the one or more embodiments.

Memory 904 can comprise volatile memory (e.g., random access memory (RAM), static RAM (SRAM) and/or dynamic RAM (DRAM)) and/or non-volatile memory (e.g., read only memory (ROM), programmable ROM (PROM), electrically programmable ROM (EPROM) and/or electrically erasable programmable ROM (EEPROM)) that can employ one or more memory architectures.

Processing unit 906 can comprise one or more types of processors and/or electronic circuitry (e.g., a classical processor and/or like processor) that can implement one or more computer and/or machine readable, writable and/or executable components and/or instructions that can be stored at memory 904. For example, processing unit 906 can perform one or more operations that can be specified by computer and/or machine readable, writable, and/or executable components and/or instructions including, but not limited to, logic, control, input/output (I/O) and/or arithmetic. In one or more embodiments, processing unit 906 can be any of one or more commercially available processors. In one or more embodiments, processing unit 906 can comprise one or more central processing unit, multi-core processor, microprocessor, dual microprocessors, microcontroller, System on a Chip (SOC), array processor, vector processor, and/or another type of processor. The examples of processing unit 906 can be employed to implement one or more embodiments described herein.

The system bus 905 can couple system components including, but not limited to, the system memory 904 to the processing unit 906. The system bus 905 can comprise one or more types of bus structure that can further interconnect to a memory bus (with or without a memory controller), a peripheral bus, and/or a local bus using one or more of a variety of commercially available bus architectures. The system memory 904 can include ROM 910 and/or RAM 912. A basic input/output system (BIOS) can be stored in a non-volatile memory such as ROM, erasable programmable read only memory (EPROM) and/or EEPROM, which BIOS contains the basic routines that help to transfer information among elements within the computer 902, such as during startup. The RAM 912 can include a high-speed RAM, such as static RAM for caching data.

The computer 902 can include an internal hard disk drive (HDD) 914 (e.g., EIDE, SATA), one or more external storage devices 916 (e.g., a magnetic floppy disk drive (FDD), a memory stick or flash drive reader and/or a memory card reader) and/or a drive 920, e.g., such as a solid state drive or an optical disk drive, which can read or write from a disk 922, such as a CD-ROM disc, a DVD and/or a BD. Additionally, and/or alternatively, where a solid-state drive is involved, disk 922 could not be included, unless separate. While the internal HDD 914 is illustrated as located within the computer 902, the internal HDD 914 can also be configured for external use in a suitable chassis (not shown). Additionally, while not shown in computing system 900, a solid-state drive (SSD) can be used in addition to, or in place of, an HDD 914. The HDD 914, external storage device 916 and drive 920 can be connected to the system bus 905 by an HDD interface 924, an external storage interface 926 and a drive interface 928, respectively. The HDD interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 912, including an operating system 930, one or more applications 932, other program modules 934 and/or program data 936. All or portions of the operating system, applications, modules, and/or data can also be cached in the RAM 912. The systems and/or methods described herein can be implemented utilizing one or more commercially available operating systems and/or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In a related embodiment, operating system 930 can comprise one virtual machine (VM) of multiple VMs hosted at computer 902. Furthermore, operating system 930 can provide runtime environments, such as the JAVA runtime environment or the .NET framework, for applications 932. Runtime environments are consistent execution environments that can allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and/or settings for an application.

Further, computer 902 can be enabled with a security module, such as a trusted processing module (TPM). For instance, with a TPM, boot components hash next in time boot components and wait for a match of results to secured values before loading a next boot component. This process can take place at any layer in the code execution stack of computer 902, e.g., applied at application execution level and/or at operating system (OS) kernel level, thereby enabling security at any level of code execution.

An entity can enter and/or transmit commands and/or information into the computer 902 through one or more wired/wireless input devices, e.g., a keyboard 938, a touch screen 940 and/or a pointing device, such as a mouse 942. Other input devices (not shown) can include a microphone, an infrared (IR) remote control, a radio frequency (RF) remote control, and/or other remote control, a joystick, a virtual reality controller and/or virtual reality headset, a game pad, a stylus pen, an image input device, e.g., camera, a gesture sensor input device, a vision movement sensor input device, an emotion or facial detection device and/or a biometric input device, e.g., fingerprint and/or iris scanner. These and other input devices can be connected to the processing unit 906 through an input device interface 944 that can be coupled to the system bus 905, but can be connected by other interfaces, such as a parallel port, an IEEE 1394 serial port, a game port, a USB port, an IR interface and/or a BLUETOOTH® interface.

A monitor 946 or other type of display device can be alternatively and/or additionally connected to the system bus 905 via an interface, such as a video adapter 948. In addition to the monitor 946, a computer typically includes other peripheral output devices (not shown), such as speakers and/or printers.

The computer 902 can operate in a networked environment using logical connections via wired and/or wireless communications to one or more remote computers, such as a remote computer 950. The remote computer 950 can be a workstation, a server computer, a router, a personal computer, portable computer, microprocessor-based entertainment appliance, a peer device and/or other common network node, and typically includes many or all of the elements described relative to the computer 902, although, for purposes of brevity, only a memory/storage device 952 is illustrated. Additionally, and/or alternatively, the computer 902 can be coupled (e.g., communicatively, electrically, operatively and/or optically) to one or more external systems, sources, and/or devices (e.g., computing devices, communication devices and/or like device) via a data cable (e.g., High-Definition Multimedia Interface (HDMI), recommended standard (RS) 232 and/or Ethernet cable).

In one or more embodiments, a network can comprise one or more wired and/or wireless networks, including, but not limited to, a cellular network, a wide area network (WAN) (e.g., the Internet) or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and/or non-proprietary communication protocols. In a related example, one or more embodiments described herein can include hardware (e.g., a central processing unit (CPU), a transceiver and/or a decoder), software (e.g., a set of threads, a set of processes and/or software in execution) and/or a combination of hardware and/or software that facilitates communicating information among one or more embodiments described herein and external systems, sources, and/or devices (e.g., computing devices and/or communication devices).

The logical connections depicted include wired/wireless connectivity to a local area network (LAN) 954 and/or larger networks, e.g., a wide area network (WAN) 956. LAN and WAN networking environments can be commonplace in offices and companies and can facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired and/or wireless communication to the LAN 954, which can also include a wireless access point (AP) disposed thereon for communicating with the adapter 958 in a wireless mode.

When used in a WAN networking environment, the computer 902 can include a modem 960 and/or can be connected to a communications server on the WAN 956 via other means for establishing communications over the WAN 956, such as by way of the Internet. The modem 960, which can be internal and/or external and a wired and/or wireless device, can be connected to the system bus 905 via the input device interface 944. In a networked environment, program modules depicted relative to the computer 902 or portions thereof can be stored in the remote memory/storage device 952. The network connections shown are merely exemplary and one or more other means of establishing a communications link among the computers can be used.

When used in either a LAN or WAN networking environment, the computer 902 can access cloud storage systems or other network-based storage systems in addition to, and/or in place of, external storage devices 916 as described above, such as but not limited to, a network virtual machine providing one or more aspects of storage and/or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, such as with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices and/or entities operatively disposed in wireless communication, e.g., a printer, scanner, desktop, and/or portable computer, portable data assistant, communications satellite, telephone, and/or any piece of equipment or location associated with a wirelessly detectable tag (e.g., a kiosk, news stand and/or store shelf). This can include Wireless Fidelity (Wi-Fi) and BLUETOOTH® wireless technologies. Thus, the communication can comprise a defined structure as with a conventional network or simply an ad hoc communication between at least two devices.

The illustrated embodiments described herein can be employed relative to distributed computing environments (e.g., cloud computing environments), such as described below with respect to FIG. 10, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1002 described below with reference to illustration 1000 of FIG. 10. For instance, one or more embodiments described herein and/or components thereof can employ such one or more resources to execute one or more: mathematical function, calculation and/or equation;

computing and/or processing script; algorithm; model (e.g., artificial intelligence (AI) model, machine learning (ML) model, deep learning (DL) model, and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting architectures 100 and or 200, and/or the example computing system 900 of FIG. 9, can be associated with and/or be included in cloud-based and/or partially-cloud-based system.

Referring now to details of one or more elements illustrated at FIG. 10, the illustrative cloud computing environment 1002 is depicted. Cloud computing environment 1002 can comprise one or more cloud computing nodes and/or virtual machines with which are used by clients 1004, such as the computer 902. The client 1004 (e.g., client entity) has a processor 1006, network interface card (NIC) 1008, storage 1010 which holds the operating system 1012 and any applications 1014, and RAM 1016 which stores the executing operating system 1018 and applications 1020. The client 1004 is connected to the cloud computing environment 1002 by a network 1003, such as the Internet.

The cloud computing environment 1002 is illustrated as having three servers 1030A, 1030B and 1030C. Each server 1030A-1030C includes three virtual machines 1032, with server 1030A including VMs 1032A-1032C, server 1030B including VMs 1032D-1032E and server 1030C including VMs 1032F-1032G; and a hypervisor 1034A-1034C. More detail is provided of server 1030A as exemplary of the servers 1030B and 1030C. The server 1030A includes a processing unit 1040, a NIC 1042, RAM 1044 and non-transitory storage 1046. The RAM 1044 includes the operating virtual machines 1032A-1032C and the operating hypervisor 1034A. The non-transitory storage 1046 includes stored versions of the host operating system 1050, the virtual machine images 1052 and the stored version of the hypervisor 1054. The servers 1030, 1030B and 1030C are connected by a network in the cloud computing environment 1002 to allow access to the network 1003 and the client 1004.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to conduct aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a defined manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform defined tasks and/or implement abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based consumer and/or industrial electronics and/or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more functionalities. The entities described herein can be either hardware, a combination of hardware and software, software or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a forecasting component that, based on performance data for a storage system, forecasts a performance metric for a storage unit subset of the storage system,
wherein the performance metric is based on saturation of a capacity at the storage system related to the storage unit subset; and
an execution component that executes a modification at the storage system,
wherein the modification at the storage system comprises changing a functioning of the storage system relative to the storage unit subset.

2. The system of claim 1, wherein the execution component executes the modification based on a ranking of severity of the performance metric.

3. The system of claim 1, wherein the performance metric is based on at least one of a storage capacity or a performance capacity for the storage unit subset.

4. The system of claim 2, wherein the execution component executes the modification further based on a proactive determination of downstream effect of the modification.

5. The system of claim 1, further comprising:
a ranking component that evaluates a combination of storage capacity and performance capacity caused by functioning of the storage unit subset,
wherein the storage unit subset comprises a storage volume, and
wherein the ranking component further provides a ranking corresponding to the storage unit subset based on an aggregation of the storage capacity and performance capacity.

6. The system of claim 1, wherein the execution component further executes one or more additional modifications at the storage system until a measured level of saturation of capacity at the storage system corresponding to the storage unit subset satisfies a threshold value.

7. The system of claim 1, further comprising an evaluation component that based on the modification, at the storage system, re-evaluates current performance data for the storage system and determines whether a measured level of saturation of capacity at the storage system satisfies a threshold value.

8. The system of claim 1,
wherein the forecasting component, based on the performance data for the storage system, forecasts a second performance metric for a second storage unit subset of the storage system, and
wherein the execution component, based on a ranking of the second performance metric as compared to the performance metric, executes a second modification, at the storage system, relative to the second storage unit subset.

9. The system of claim 1, further comprising:
a model that forecasts the performance metric for use by the forecasting component,
wherein the model comprises or is comprised by a machine learning model.

10. A computer-implemented method, comprising:
forecasting, by a processor, based on performance data for a storage system, a performance metric for a volume of an aggregate of the storage system,
wherein the performance metric is based on saturation of at least one of storage capacity or performance capacity at the storage system caused by functioning of the volume; and
executing, by the processor, a modification at the storage system,
wherein the modification at the storage system comprises changing a functioning of the storage system relative to the volume.

11. The computer-implemented method of claim 10, further comprising executing, by the processor, the modification based on a ranking of severity of the performance metric.

12. The computer-implemented method of claim 11, further comprising executing, by the processor, the modification further based on a proactive determination of downstream effect of the modification.

13. The computer-implemented method of claim 10, further comprising
evaluating, by the processor, a combination of storage capacity and performance capacity caused by functioning of the volume; and
ranking, by the processor, a priority of modifying the storage system based on an aggregation of the storage capacity and performance capacity.

14. The computer-implemented method of claim 10, further comprising
determining, by the processor, an optimal utilization range for storage capacity or performance capacity for the volume; and
triggering, by the processor, the forecasting in a case where the volume is operating outside of the optimal utilization range.

15. The computer-implemented method of claim 10, further comprising executing, by the processor, one or more additional modifications until a measured level of saturation of capacity at the storage system corresponding to the volume satisfies a threshold value for non-saturated functioning.

16. A computer program product facilitating an automated process to determine and apply a modification at a storage system, the computer program product comprising a computer readable storage medium having program instructions embodied therewith, the program instructions executable by a processor to cause the processor to execute operations, the operations comprising:
obtaining, by the processor, performance data for a volume of an aggregate of the storage system;
forecasting, by the processor, based on the performance data, a capacity performance metric for the volume;
wherein the performance metric is based on saturation of at least one of storage capacity or performance capacity at the storage system caused by functioning of the volume;
ranking, by the processor, a priority of modifying the storage system based on the at least one of the storage capacity or the performance capacity;
determining, by the processor, a modification for addressing the performance metric; and
executing, by the processor, based on the ranking, the modification of the storage system,
wherein the modification causes a level of saturation of capacity at the storage system corresponding to the volume to adjust closer to a selected threshold value.

17. The computer program product of claim 16, wherein the operations further comprise
comparing, by the processor, a performance metric for the volume to a performance metric for a second volume; and
providing, by the processor, the ranking relative to the volume based on the comparing.

18. The computer program product of claim 16, wherein the operations further comprise:
re-evaluating, by the processor, based on the modification at the storage system, performance data for the storage system; and
determining, by the processor, whether a measured level of saturation of capacity at the storage system satisfies the selected threshold value.

19. The computer program product of claim 16, wherein the operations further comprise executing, by the processor, one or more additional modifications until a measured level of saturation of capacity corresponding to the threshold satisfies the threshold value.

20. The computer program product of claim 16, wherein the operations further comprise
determining, by the processor, an optimal utilization range for storage capacity or performance capacity for the volume; and
triggering, by the processor, the forecasting in a case where the volume is operating outside of the optimal utilization range.
